(19) United States
(12) Patent Application Publication
(10) Pub. No.: US 2009/0027696 A1
(43) Pub. Date: Jan. 29, 2009

(54) PRINTMODE ARCHITECTURE

(76) Inventors: Jason M. Quintana, Brush Prairie, WA (US); Marc Yousey, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/782,480

(22) Filed: Jul. 24, 2007

(51) Int. Cl. G06F 3/12

(52) U.S. Cl. 358/1.1

(57) ABSTRACT

A system for generating a print mode is provided. The system includes a print mode file, a printer configuration unit, and a print mode engine. The print mode file includes high-level descriptions of the print mode. The printer configuration unit includes configuration data associated with a printer. The print mode engine is configured to receive the high-level descriptions and the configuration data. The print mode engine generates a print mode based on the high-level descriptions, the configuration data, and halftoned data associated with an image to be printed by the printer.

### BACKGROUND

Inkjet printers print dots by ejecting small drops of ink onto a print medium. An inkjet printer typically includes a movable carriage supporting one or more print heads, each with ink-ejecting nozzles. As the carriage moves across the surface of the print medium, the nozzles eject drops of ink at selected times. The nozzles are controlled to achieve a desired effect. For example, the timing and magnitude of the ejected ink drops may be controlled to correspond to a pattern of pixels of an image being printed.

A print mode is the inking patterns used in each pass of the carriage and the manner in which the inking patterns cumulatively form an image. Manipulation of print modes allows the printer to control various factors that influence image quality, including the amount of ink placed on the print medium at any given pixel, the speed with which the ink is placed, and the number of passes employed to complete the image.

The print mode typically defines one or more print masks used in printing an image. A print mask (i.e., shingle mask) is a pattern that defines which ink drops are printed in a given pass, which passes are used to print any given pixel, and which nozzles will be used to print any given pixel.

Inkjet printers typically utilize pre-made print modes, which are specific to a given printer configuration. With the rapid increase in the number of different inkjet printers, the creation of different print modes for each inkjet printer can be unduly burdensome in both labor and monetary cost.

For these and other reasons, there is a need for the present invention.

### SUMMARY

One embodiment provides a system for generating a print mode. The system includes a print mode file, a printer configuration unit, and a print mode engine. The print mode file includes high-level descriptions of the print mode. The printer configuration unit includes configuration data associated with a printer. The print mode engine is configured to receive the high-level descriptions and the configuration data. The print mode engine generates a print mode based on the high-level descriptions, the configuration data, and halftoned data associated with an image to be printed.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many intended advantages of embodiments will be readily appreciated as they become better understood by reference to the following detailed description. The elements of the drawings are not necessarily to scale relative to each other. Like reference numerals designate corresponding similar parts.

FIG. 1 illustrates a block diagram of a print mode architecture.

FIG. 2 illustrates a state diagram of swath cutting state machine in accordance with one embodiment.

FIG. 3 illustrates a diagram of a page of halftoned data to be examined by swath cutting state machine in accordance with one embodiment.

FIG. 4 illustrates a block diagram of a print mode architecture in accordance with one embodiment.

FIG. 5 illustrates a flow diagram of a method of configuring swath cutting state machine in accordance with one embodiment.

FIG. 6 illustrates a dispersion of dots resulting from Floyd-Steinberg error diffusion in accordance with one embodiment.

FIG. 7 illustrates a dispersion of dots resulting from tone dependent error diffusion in accordance with one embodiment.

FIG. 8 illustrates a flow diagram of a method of generating a print mask in accordance with one embodiment.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

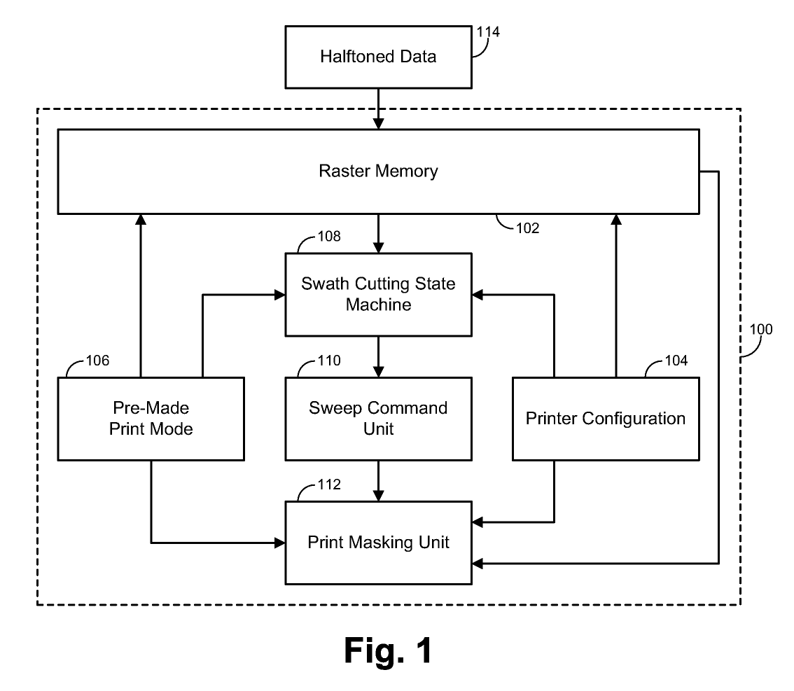

FIG. 1 illustrates a block diagram of a print mode architecture 100. Print mode architecture 100 includes a raster memory 102, a printer configuration 104, a pre-made print mode 106, a swath cutting state machine 108, a sweep command unit 110, and a print masking unit 112. Raster memory 102 is operatively connected to printer configuration 104, pre-made print mode 106, and swath cutting state machine 108. Swath cutting state machine 108 is operatively connected to printer configuration 104, pre-made print mode 106, and sweep command unit 110. Print masking unit 112 is operatively connected to printer configuration 104, pre-made print mode 106, and sweep command unit 110.

Pre-made print mode 106 is a data file typically stored in a read-only memory (ROM). Printer configuration 104 is representative of components which make up the printer at a given moment. Printers are typically built with different sets of application specific integrated circuits (ASICs), and a customer can choose what supplies are installed in a given printer. In some printers, some supplies might be empty and un-available for customer use. Thus, printer configuration 104 is not static.

Halftoned data 114, which is rendered from an image to be printed, is sent to and stored in raster memory 102. Swath cutting state machine 108, based on input from printer configuration 104 and pre-made print mode 106, receives halftoned data 114 and converts halftoned data 114 into sweep data, which is a collection of rasters appropriate for the printing device to print as the carriage sweeps the print head over the print medium (e.g., paper). In other words, the halftoned data 114 is broken up into the raster that is used on each pass of the printhead. Exactly what rasters are in each sweep is dependent on many factors. Sweep command unit 110 receives the sweep data and converts the sweep data into sweep commands for moving the carriage and advancing the print medium as it is fed through the printer. Print masking unit 112, based on input from printer configuration 104, pre-made print mode 106, and sweep command unit 110, applies a print mask stored in the pre-made print mode 106. The print mask determines the operation of the print head during each pass.

Printer configuration 104 includes configuration data of the printer, such as the size of raster memory 102, the type of ASICs utilized by the printer, and the number and color of pens installed. Pre-made print mode 106 includes printer control data, such as the speed with which the ink is placed, (i.e., speed of the carriages slew) the number of passes required to print the image, and how fast and how far to advance the print medium.

Print mode architecture 100 exhibits a number of potential drawbacks. First, both printer configuration 104 and pre-made print mode 106 communicate with the same blocks in print mode architecture 100, namely raster memory 102, swath cutting state machine 108, and print masking unit 112. Thus, raster memory 102, swath cutting state machine 108, and print masking unit 112 will not operate properly unless both printer configuration 104 and pre-made print mode 106 are functional. Thus, if printer configuration 104 changes, pre-made print mode 106 can potentially fail. The likelihood of failure of pre-made print mode 106 increases with the advancement of inkjet printers. For example, an inkjet printer may support, among other things, different paper sizes ranging from 4×6 to B+, different pen carriages ranging from 1-pen carriages to 3-pen carriages, different swath height black pens (e.g., 9/16″, ⅓″), different color pens (e.g., color, photo, gray, blue), and print jobs from different sources (e.g., host, copy, memory card). Pre-made print mode 106 may not be capable of handling the potentially numerous configuration changes available.

Further, pre-made print mode 106 is typically statically defined by certain aspects of the printer, such as the number of nozzles available and the colors of pens installed. For example, a 4-pass print mode for a 100-nozzle print head may instruct a printer device to advance the print medium twenty-five nozzles on each pass. If pre-made print mode 106 is statically defined by aspects of the printer that can be changed, then different print modes need to be created for each possible alternative.

Storing a large number of print modes can consume a considerable amount of memory, such as random access memory (RAM) and ROM. An exemplary printer may employ at least 700K bytes of memory for storing all the different print modes. Further, pre-made print modes tend to be larger and consume more resources during printing because they are typically created under worst-case conditions, such as the largest possible page size (e.g., B+) and largest number of colors installed, even if a particular print job may be completed utilizing a smaller-sized, lower resource print mode (e.g., for a 4×6 page when fewer colors are installed).

Additionally, because the print modes are pre-made, the size of the print modes remain static. Thus, the pre-made print modes are not capable of utilizing extra memory that may become available. Further, the pre-made print modes are not capable of reducing in size to increase available memory when other jobs need the extra memory (e.g., scanning an image back to the host).

Embodiments provide an adaptive print mode architecture that readily adapts to potential configuration changes in the printing device. The print mode can be created dynamically and does not need to be pre-made. Further, the print mode can be created utilizing only the amount of memory necessary or available to complete a given print job. The adaptive print mode architecture is a universal, durable, and portable format that can be shared between inkjet printers.

In one embodiment, the adaptive print mode architecture includes a first feature related to the automatic configuration of swath cutting state machine 108. In one embodiment, the adaptive print mode architecture includes a second feature related to the generation of print masks in print masking unit 112 using error diffusion. Both features are described in greater detail below.

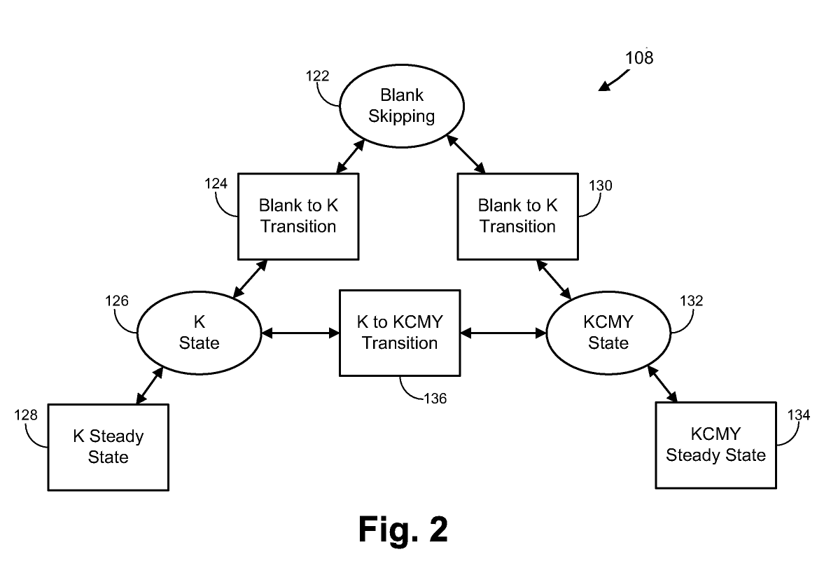

FIG. 2 illustrates a state diagram of swath cutting state machine 108 in accordance with one embodiment. The process of swath cutting, which converts halftoned data to sweep data, can be readily modeled using a state machine, such as swath cutting state machine 108. Swath cutting state machine 108 includes a blank_skipping state 122, a K state 126, and a KCMY state 132. Additionally, swath cutting state machine 108 includes transitions between each state (i.e., information on how to transition between states). Every transistion (which includes steady state transitions back to themselves) involves a test and actions to perform if the test is true, such as a blank_to_K transition 124, a blank_to_KCMY transition 130, and a K_to_KCMY transition 136. Further, swath cutting state machine 108 includes transitions from each state to itself, such as K steady state 128 and KCMY steady state 134. Each transition includes specific instructions for printer actions, such as what nozzles to use, and how far to advance the print medium. As used herein, K refers to the color black, C refers to the color cyan, M refers to the color magenta, and Y refers to the color yellow.

In another example embodiment, swath cutting state machine 108 includes eight states: three states for printing text (i.e., black-only, color-only, and black and color), two states for printing graphics (i.e., black-only and black and color), two starting states (i.e., bordered and borderless), and a blank skipping state, as well as all the possible transitions. In one embodiment, there are transitions from every state to every other state, including to itself. In other embodiments, swath cutting state machine 108 includes any suitable number of states and transitions.

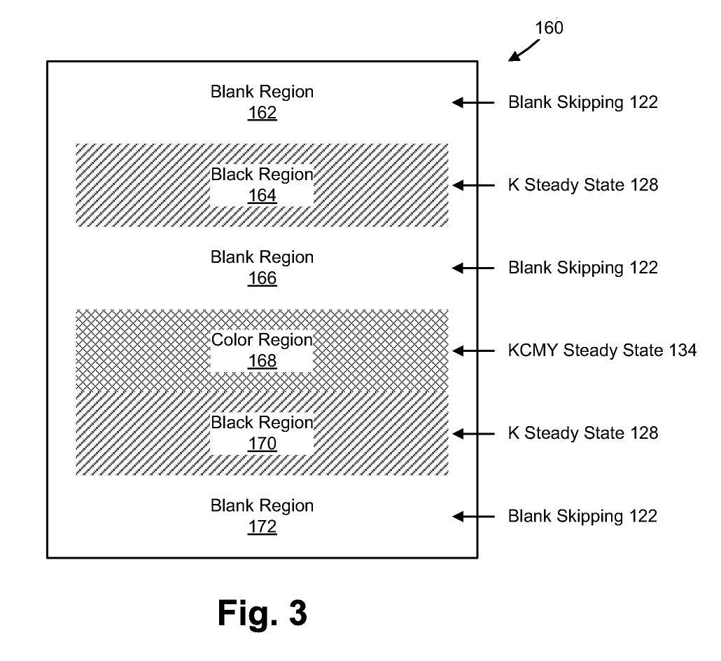

FIG. 3 illustrates a diagram of a page 160 of halftoned data to be examined by swath cutting state machine 108 in accordance with one embodiment. For illustrative purposes only, it is assumed that swath cutting state machine 108 begins the examination of page 160 at the top of page 160 and continuously advances until the end of page 160.

With reference to FIGS. 2 and 3, the first region encountered is a first blank region 162, which causes swath cutting state machine 108 to enter blank skipping state 122. The second region encountered is first black region 164, which causes swath cutting state machine 108 to transition from blank skipping state 122 to K state 126 via blank_to_K transition 124. In K state 126, swath cutting state machine 108 repeatedly executes K steady state 128 until encountering the next region. The third region encountered is a second blank region 166, which causes swath cutting state machine 108 to transition from K state 126 to blank skipping state 122 via blank_to_K transition 124. The fourth region encountered is color region 168, which causes swath cutting state machine to transition from blank skipping state 122 to KCMY state 132 via blank_to_KCMY transition 130. In KCMY state 132, swath cutting state machine 108 repeatedly executes KCMY steady state 134 until encountering the next region. The fifth region encountered is second black region 170, which causes swath cutting state machine to transition from KCMY state 132 to K state 126 via K_to_KCMY transition 136. In K state 126, swath cutting state machine 108 repeatedly executes K steady state 128 until encountering the next region. The sixth region encountered is third blank region 172, which causes swath cutting state machine to transition from K state 126 to blank skipping state 122 via blank_to_K transition 124.

In one embodiment, the states of swath cutting state machine 108 fall under one of three state categories: blank skipping states, black-only states, and black and color states. Blank skipping states refer to those states related to advancing the print medium without firing ink, effectively rendering blank space on the print medium. Black-only states refer to those states related to firing only black ink on the print medium. Black and color states refer to those states related to firing black and color ink on the print medium.

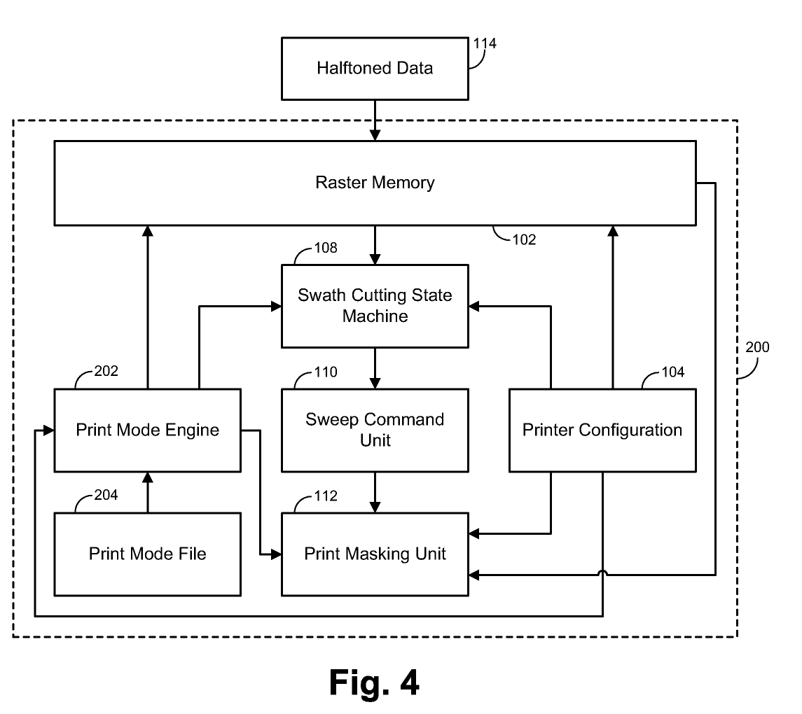

FIG. 4 illustrates a block diagram of a print mode architecture 200 in accordance with one embodiment. Print mode architecture 200 includes a raster memory 102, a printer configuration 104, a swath cutting state machine 108, a sweep command unit 110, a print masking unit 112, a print mode engine 202, and a print mode file 204. Print mode file 204 is a high level description of a desired printing result rather than desired actions to perform. Raster memory 102 is operatively connected to printer configuration 104, swath cutting state machine 108, and print mode engine 202. Swath cutting state machine 108 is operatively connected to printer configuration 104, sweep command unit 110, and print mode engine 202. Print masking unit 112 is operatively connected to printer configuration 104, sweep command unit 110, and print mode engine 202. Print mode engine 202 is further operatively connected to printer configuration 104 and print mode file 204.

Halftoned data 114, which is rendered from an image to be printed, is sent to and stored in raster memory 102. Swath cutting state machine 108, based on input from printer configuration 104 and print mode engine 202, receives halftoned data 114 and converts halftoned data 114 into sweep data, which is a collection of rasters appropriate for the printing device to print as the carriage sweeps the print head over the print medium. Sweep command unit 110 receives the sweep data and converts the sweep data into sweep commands for moving the carriage and advancing the print medium as it is fed through the printer. In one embodiment, print masking unit 112, based on input from printer configuration 104, sweep command unit 110, and print mode engine 202 generates a print mask, which determines the operation of the print head during each pass. In another embodiment, the print mask is generated at the top of the page and stored, and print masking unit 112 retrieves the print mask and may modify the print mask as desired.

Print mode engine 202 receives data from print mode file 204 for configuring swath cutting state machine 108 and for aiding print masking unit 112 in generating the print mask. In one embodiment, print mode file 204 is a high-level description of the print mode that avoids defining the print mode by the fixed number of nozzles present in a printer's writing system. Print modes conventionally are typically defined mostly in terms of nozzles, sweep using these nozzles, look under this range of nozzles for data, advance this many nozzles, etc. Since the number and resolution of the nozzles can change with configuration, the print mode conventionally is typically defined in nozzles. Examples of descriptions that may be included in print mode file 204 include the desired set of colors used for printing, the number of passes made by the carriage, the print resolution, and the number of ink drops at each location. Providing a high level description reduces the amount of storage needed to store print mode file 204. Further, by not defining the print mode in terms of nozzles, print mode file 204 can be utilized on multiple writing systems. In one embodiment, the high-level descriptions provide what is expected from a user regarding the operation of the printer irrespective of the printer hardware while printer configuration 104 provides the hardware configuration available to the printer. In one embodiment, print mode engine 202 configures swath cutting state machine 108 by analyzing and balancing the high-level descriptions of print mode file 204, the configuration data of printer configuration 104, and halftoned data 114.

As used herein, “configuring” swath cutting state machine 108 refers generally to determining which states and transitions will be used in swath cutting state machine 108 and what each transition will do. As described above, each transition comprises a test and actions to perform if the test is true. In one embodiment, determining which states and transitions will be used in swath cutting state machine 108 is a function of the descriptions provided in print mode file 204. In one embodiment, the data included in print mode file 204 is analyzed to determine the fastest method of printing. For example, if print mode file 204 indicates that black and color regions will be printed at the same pen height as black-only regions, then certain transitions can be constructed for faster print speed than if the heights were different. In one embodiment, determining what each transition will do involves determining the operations of components in the printing device. For example, a transition may involve calculating the number of nozzles to use, how fast and how much to move the motors, which print masks to use, and the like.

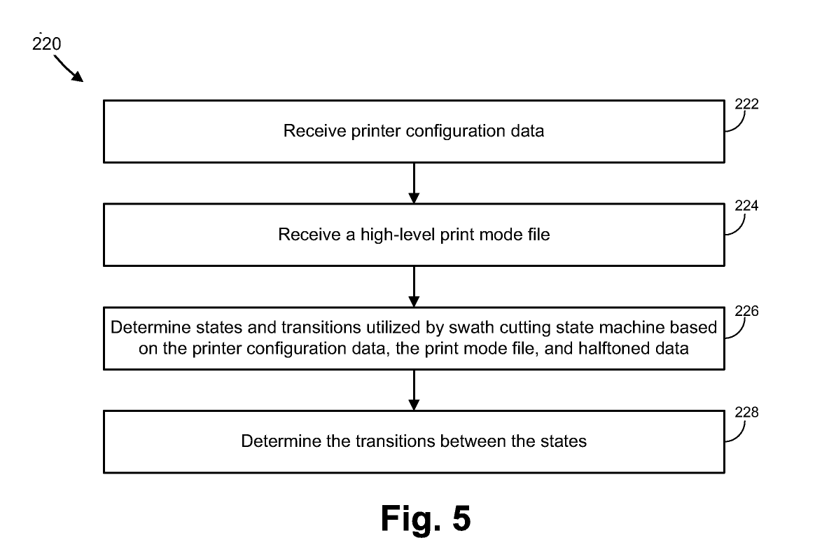

FIG. 5 illustrates a flow diagram of a method 220 of configuring swath cutting state machine 108 in accordance with one embodiment. Referring to FIGS. 4 and 5, print mode engine 202 receives (at 222) the configuration data from printer configuration 204. The hardware configuration data may include, among other things, the size of raster memory 102, the type of ASICs utilized by the printing device (this affects how many nozzles/pens can be fired in one sweep, whether each pen has to be fired at the same resolution or not, how big the print mask can be, etc), and the color of pens installed. Print mode engine 202 also receives (at 224) print mode file 204. In one embodiment, print mode file 204 includes high-level descriptions of the print mode, and print mode engine 202 utilizes the high-level descriptions to configure swath cutting state machine 108.

Print mode engine 202 determines (at 226) the states and transitions utilized by swath cutting state machine 108 based on halftoned data 114, printer configuration 104, and print mode file 204.

Print mode engine 202 determines (at 228) the transitions between the states of swath cutting state machine 108. In one embodiment, the transitions between the states are determined for optimal or near-optimal performance based on the configuration data of printer configuration 104. In one embodiment, determining the transitions between the states of the swath cutting state machine 108 involves determining the lengths at which to advance the print medium (i.e., the advance lengths) and the number of nozzles utilized to print halftoned data 114 (i.e., the nozzle range). In one embodiment, determining the states and transitions utilized by swath cutting state machine 108 involves determining how quickly ink is fired (i.e., the sweep or fire resolution). In one embodiment, determining the states utilized by swath cutting state machine 108 involves sizing print masks to a maximum quality based on the configuration data of printer configuration 104 (e.g., type of ASIC employed by printing device).

A print mask (i.e., shingle mask) is generally designed to avoid or minimize visual defects created by one or more of line feed advance errors, pen alignment errors, ink media interactions, dead nozzles, and the like. In one embodiment, the print mask includes non-repeating, spatially dispersed patterns to hide banding or missing nozzles. In one embodiment the print mask includes temporally dispersed patterns allowing ink in one area to dry before firing in an adjacent area. In one embodiment of the print mask, each intended dot is fired only once (i.e., lossless printing where if the print masks used on all passes are added together, the print masks “sum to one”). In one embodiment the print mask is tunable and able to control the relative use of each nozzle for tapering and dead nozzle compensation. In one embodiment, the print mask is capable of tiling with itself. In one embodiment, the print mask is optimized with respect to style and size based on the available memory. In other words, the size of the print mask and the style or features built into the print mask is dependent on available memory in the ASIC to apply to the print mask and in ROM or RAM to store masks before they are employed.

Techniques for generating print masks include matrix-based methods. Matrix-based methods are generally computationally intensive, which may be inapplicable for low-end printers, and in particular, low-end printer firmware. Embodiments of error diffusion-based methods for generating print masks are presented herein. One or more embodiments are computationally efficient and suitable for low-end printers and low-end printer firmware. Further, one or more error diffusion-based method embodiments are computationally efficient because, among other things, each pixel is viewed only once. Other mask generation methods use what amounts to multiple passes of iteration or to reload a given mask location from memory over and over while doing other mask locations.

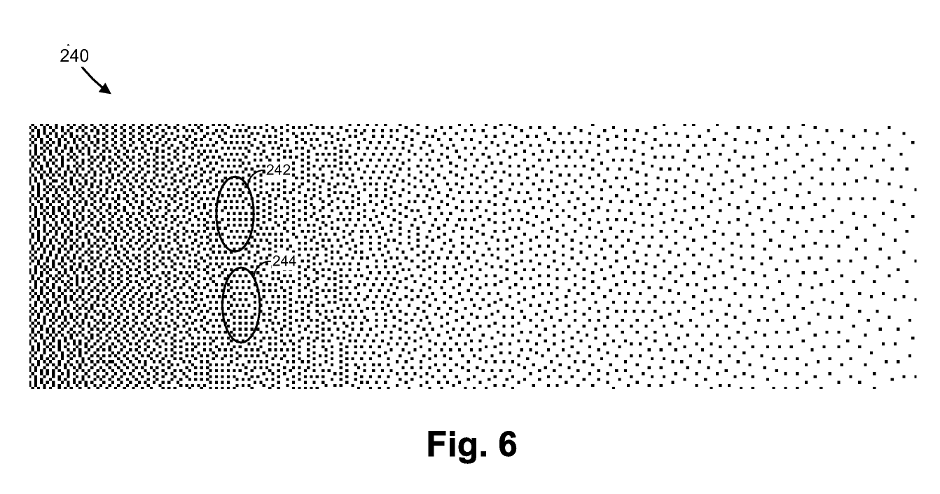

FIG. 6 illustrates a dispersion 240 of dots resulting from Floyd-Steinberg error diffusion in accordance with one embodiment. A problem with the Floyd-Steinberg method is the generation of repeating patterns of horizontal and/or vertical lines among the dispersion 240. For example, dispersion 240 includes repeating patterns at 242 and at 244.

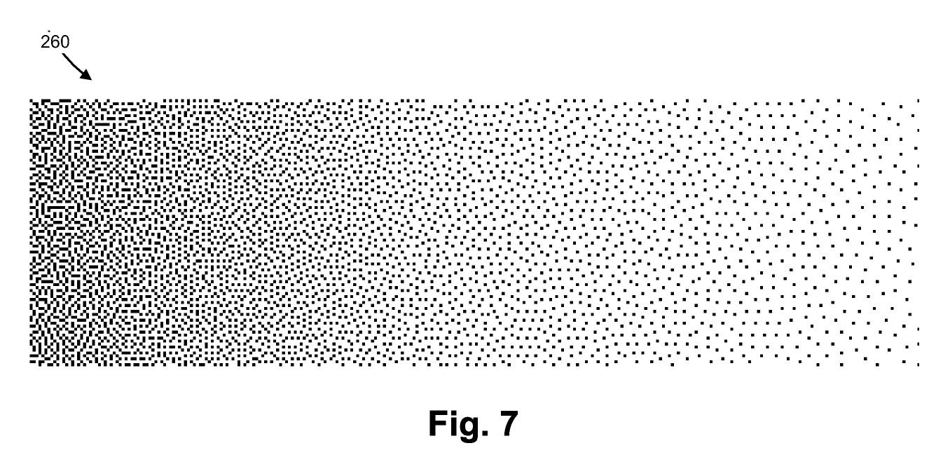

FIG. 7 illustrates a dispersion 260 of dots resulting from tone dependent error diffusion in accordance with one embodiment. With tone dependent error diffusion, the weights, thresholds, and injections of noise are controlled for each input tone. To achieve optimal quality, the weights, thresholds, and injections of noise may be determined via a suitable training process. A suitable training process includes training the parameters to yield an output of a desired spatial or frequency domain result. Tone dependent error diffusion resolves the problem of repeating patterns present when using Floyd-Steinberg error diffusion. Referring to FIGS. 6 and 7, dispersion 260 does not include repeating patterns present in dispersion 240, such as at 242 and at 244.

While tone dependent error diffusion is an improvement over Floyd-Steinberg error diffusion, tone dependent error diffusion does not account for color interactions associated with color printing. For example, tone dependent error diffusion does not account for the positioning of different color dots relative to each other. The distribution of various colored dots on the print medium may affect visibility and distinctiveness of the individual colors. Further, avoiding unintended overlap of colored dots is important to maintain the integrity of the desired colors. For example, overlapping cyan and magenta will create blue.

To resolve the overlapping problem associated with color printing, plane-dependent error diffusion can be utilized. Plane dependent error diffusion essentially operates by adding together two or more colors of dots (e.g., cyan and magenta), half-toning the combined dots to create a monochromatic color, and assigning a color (e.g., cyan or magenta) for each half-toned dot. By assigning a color to each half-toned monochromatic dot, it is ensured that no two dots will overlap. Thus, plane-dependent error diffusion ensures summing to one.

While plane-dependent error diffusion prevents overlapping dots, it does not account for the distribution of similarly colored dots. Thus, the spacing between similarly colored dots may not be optimal, resulting in repeating patterns of similarly colored dots. To resolve the problems of plane-dependent error diffusion, sequential dependent error diffusion can be utilized. With sequential dependent error diffusion, each color plane is half-toned separately while metrics based on the errors are passed between the planes. The result of sequential dependent error diffusion is improved overall patterns and improved individual patterns.

Assuming that each color plane is a print sweep, tone dependent error diffusion provides non-repeating patterns and adjustability. Plane dependent error diffusion ensures summing to one. Sequential dependent error diffusion ensures that each pass is spaced evenly from other passes, thereby satisfying temporal requirements. Further, error diffusion by nature provides control of dot density, thereby providing control over relative nozzle usage.

An N-color error diffusion method of generating a print mask is created by combining tone-dependent error diffusion, plane-dependent error diffusion, and sequential dependent error diffusion. The tone-dependent parameters, such as the weights, thresholds, and injections of noise, are retrained for the generation of print masks. The error diffusion-based method of generating print masks is also adjusted to enable a generated print mask to tile with itself.

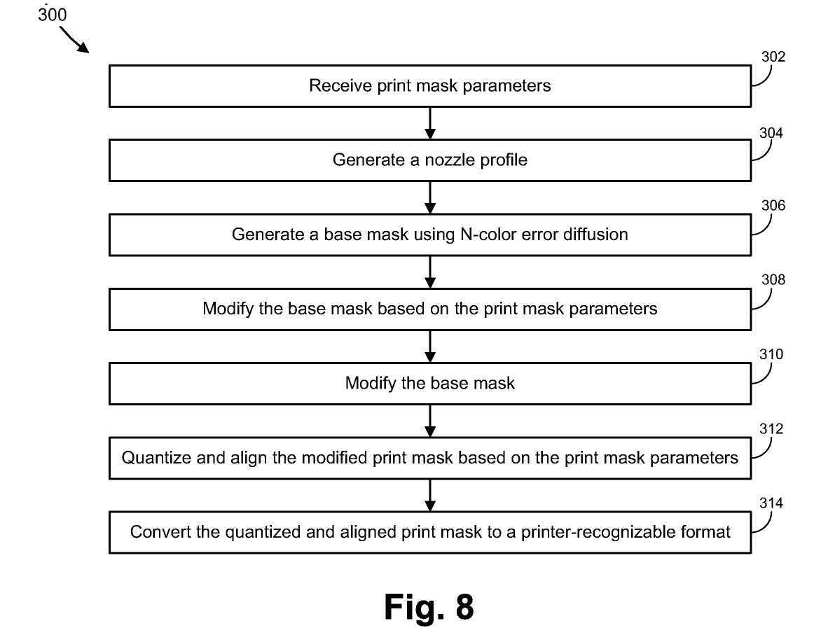

FIG. 8 illustrates a flow diagram of a method 300 of generating a print mask in accordance with one embodiment. Referring to FIGS. 4 and 8, print masking unit 112 receives (at 302) print mask parameters from print mode engine 202. In one embodiment, the print mask parameters are provided to print mode engine 202 from print mode file 204. Print mask parameters include any suitable options related to generating a print mask, including nozzle range used, number of passes, advance length, mask width, vertical nozzle resolution, firing resolution, halftone data resolution, and drop levels used.

Print masking unit 112 generates (at 304) a nozzle profile. In one embodiment, the nozzle profile is generated based on data received from printer configuration 104. The nozzle profile includes details regarding the availability of the nozzles in the printer. In one embodiment, the nozzle profile includes compensation for dead nozzles. A base mask is generated (at 306) using N-color error diffusion. A base mask is a starter mask that can be modified later. As previously described, N-color error diffusion combines tone-dependent error diffusion, plane-dependent error diffusion, and sequential dependent error diffusion. In one embodiment, the base mask generated using N-color error diffusion compensates for most, if not all, dead nozzles by shifting firings to adjacent nozzles.

Print masking unit 112 modifies (at 308) the base mask based on at least a portion of the print mask parameters. In one embodiment, the base mask is modified to account for the ratio of vertical nozzle resolution to halftone data resolution. In one embodiment, the base mask is modified to account for the ratio of firing resolution to halftone data resolution. Print masking unit 112 further modifies (at 310) the base mask. In one embodiment, base mask is modified based on the nozzle profile. In another embodiment, base mask is modified based on a new nozzle profile. In one embodiment, the base mask is modified to further compensate for any dead nozzles not compensated when the base mask was generated, which may occur, for example, when multiple dead nozzles partner with each other. In other words, if the same location of the page has all the nozzles that print to it dead, in this embodiment the print mask is modified to attempt to print that data with neighboring nozzles in adjacent page locations.

Print masking unit 112 quantizes and aligns (at 312) the modified mask based on at least a portion of the print mask parameters. In one embodiment, the base mask is quantized to the drop levels used and is aligned to the nozzle range. Print masking unit 112 converts (at 314) the quantized and aligned mask to a format capable of being recognized by the proper printer hardware, firmware, and/or software. When the print mask is generated, the print mask is in continuous drop levels (e.g., 1, 2, 3, 4, 5, 6, 7, 8 drops per pixel), however, often the actual drop levels might be 1, 3, 8, where level 1 half-toned data is one drop, level 2 is 3 drops, and level 3 is 8 drops. Thus, the print mask is quantitized from continuous drop levels to the levels that are actually employed. Furthermore, typically the first nozzle used is not nozzle 1, so the print mask is aligned to the used nozzle range on the pen. Also, the print mask is put into the form used by the particular ASIC or software that is performing the print masking is expecting.

Embodiments described and illustrated with reference to the Figures provide systems and methods of generating a print mode It is to be understood that not all components and/or steps described and illustrated with reference to the Figures are required for all embodiments. In one embodiment, one or more of the illustrative methods are preferably implemented as an application comprising program instructions that are tangibly embodied on one or more program storage devices or machine readable storage media (e.g., hard disk, magnetic floppy disk, universal serial bus (USB) flash drive, RAM, ROM, CD ROM, etc.) and executable by any device or machine comprising suitable architecture, such as a printer or a general purpose digital computer having a processor, memory, and input/output interfaces.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system configured to generate a print mode, comprising:
a print mode file comprising high-level descriptions of the print mode;
a printer configuration unit comprising configuration data associated with a printer; and
a print mode engine configured to receive the high-level descriptions and the configuration data and generate a print mode based on the high-level descriptions, the configuration data, and halftoned data associated with an image to be printed by the printer.

2. The system of claim 1, wherein the print mode engine automatically configures a swath cutting state machine associated with the printer.

3. The system of claim 2, wherein the print mode engine determines which states and transitions to utilize in the swath cutting state machine and what each state and transition does.

4. The system of claim 3, wherein the print mode engine determines the transitions between states to achieve at least near-optimal performance based on the configuration data.

5. The system of claim 1, comprising:
a print masking unit configured to generate a print mask utilizing N-color error diffusion.

6. The system of claim 5, wherein the print masking unit generates the print mask utilizing a combination of tone-dependent error diffusion, plane-dependent error diffusion, and sequential-dependent error diffusion.

7. The system of claim 5, wherein the print masking unit generates the print mask based on data received from the print mode engine.

8. The system of claim 5, wherein the print masking unit converts the print mask to a format capable of being recognized by the printer.

9. The system of claim 1, wherein the print mode engine automatically configures a swath cutting state machine associated with the printer and generates a print mask utilizing N-color error diffusion.

10. The system of claim 1, wherein the high-level descriptions of the print mode comprise descriptions of what is expected from a user regarding operation of the printer irrespective of the configuration data.

11. The system of claim 1, wherein the high-level descriptions of the print mode avoid defining the print mode in terms of nozzles.

12. The system of claim 1, wherein the high-level descriptions include at least one of colors used for printing, number of passes made by a carriage, and print resolution.

13. The system of claim 1, wherein the configuration data comprises a number of nozzles available on the printer.

14. A system for configuring a swath cutting state machine, comprising:
a print mode file comprising high-level descriptions of a print mode;
a printer configuration unit comprising configuration data associated with a printer; and
a print mode engine configured to receive the high-level descriptions and the configuration data and determine states and transitions utilized by the swath cutting state machine based on the high-level descriptions, the configuration data, and halftoned data associated with an image to be printed by the printer.

15. The system of claim 14, wherein the print mode engine determines transitions between the states.

16. The system of claim 15, wherein the print mode engine determines the transitions between states to achieve at least near-optimal performance based on the configuration data.

17. The system of claim 14, wherein the high-level descriptions of the print mode comprise descriptions of what is expected from a user regarding operation of the printer irrespective of the configuration data.

18. The system of claim 14, wherein the high-level descriptions of the print mode avoid defining the print mode in terms of nozzles.

19. The system of claim 14, wherein the high-level descriptions include at least one of colors used for printing, number of passes made by a carriage, print resolution.

20. The system of claim 14, wherein the swath cutting state machine includes a blank-skipping state, a black-only state, and black and color state.

21. The system of claim 14, wherein the swath cutting state machine includes a black-only text state, a color-only text state, a black and color text state, a black-only graphics state, a black and color graphics state, a bordered starting state, a borderless starting state, and a blank skipping state.

22. The system of claim 14, wherein the configuration data comprises a number of nozzles available on the printer.

23. A method of configuring a swath cutting state machine, comprising:
receiving high-level descriptions of a print mode;
receiving configuration data associated with a printer; and
determining states and transitions are utilized by the swath cutting state machine based on the high-level descriptions, the configuration data, and halftoned data associated with an image to be printed by the printer.

24. The method of claim 23, further comprising determining transitions between the states.

25. The method of claim 23, wherein determining transitions between the states comprises determining transitions between the states to achieve at least near-optimal performance based on the configuration data.

26. The method of claim 23, wherein the high-level descriptions of the print mode comprise descriptions of what is expected from a user regarding operation of the printer irrespective of the configuration data.

27. The method of claim 23, wherein the high-level descriptions of the print mode avoid defining the print mode in terms of nozzles.

28. The method of claim 23, wherein the high-level descriptions include at least one of colors used for printing, number of passes made by a carriage, print resolution.

29. The method of claim 23, wherein the swath cutting state machine includes a blank-skipping state, a black-only state, and black and color state.

30. The method of claim 23, wherein the swath cutting state machine includes a black-only text state, a color-only text state, a black and color text state, a black-only graphics state, a black and color graphics state, a bordered starting state, a borderless starting state, and a blank skipping state.

31. The method of claim 23, wherein the configuration data comprises a number of nozzles available on the printer.

32. A system configured to generate a print mask, comprising:
a print mode file comprising high-level descriptions of a print mode;
a printer configuration unit comprising configuration data associated with a printer;
a print mode engine configured to receive the high-level descriptions and the configuration data and provide print mask instructions based on the high-level descriptions, the configuration data, and halftoned data associated with an image to be printed by the printer; and
a print masking unit configured to receive the print mask instructions and generate a print mask utilizing error diffusion based on the print mask instructions.

33. The system of claim 32, wherein the print mask instructions provided by the print mode engine instruct the print masking unit to generate a print mask utilizing a combination of tone-dependent error diffusion, plane-dependent error diffusion, and sequential-dependent error diffusion.

34. The system of claim 32, wherein the print mask comprises non-repeating, spatially dispersed patterns.

35. The system of claim 32, wherein the print mask comprises temporally dispersed patterns.

36. The system of claim 32, wherein the print mask is configured such that each intended dot is fired only once.

37. The system of claim 32, wherein the print mask is tunable and configured to control a relative use of each nozzle.

38. The system of claim 32, wherein the print mask is capable of tiling with itself.

39. The system of claim 32, wherein the high-level descriptions of the print mode comprise descriptions of what is expected from a user regarding operation of the printer irrespective of the configuration data.

40. The system of claim 32, wherein the high-level descriptions of the print mode avoid defining the print mode in terms of nozzles.

41. The system of claim 32, wherein the high-level descriptions include at least one of colors used for printing, number of passes made by a carriage, and print resolution.

42. The system of claim 32, wherein the configuration data comprises a number of nozzles available on the printer.

43. The system of claim 32, wherein the print masking unit converts the print mask to a format capable of being recognized by the printer.

44. A method of generating a print mask, comprising:
receiving a plurality of print mask parameters;
generating a nozzle profile relating to the availability of nozzles in a printer;
generating a base print mask utilizing N-based error diffusion;
modifying the base print mask based on a first portion of the print mask parameters to generate a first modified print mask;
modifying the first modified print mask to generate a second modified print mask;
quantizing and aligning the second modified print mask based on a second portion of the print mask parameters to generate a quantized and aligned print mask; and
converting the quantized and aligned print mask to a format capable of being recognized by the printer.

45. The method of claim 44, wherein receiving the plurality of print mask parameters comprises receiving one of a nozzle range used, a number of passes, an advance length, a mask width, a vertical nozzle resolution, a firing resolution, a halftone data resolution, and drop levels used.

46. The method of claim 44, wherein receiving the plurality of print mask parameters comprises receiving a vertical nozzle resolution, a firing resolution, and a halftone data resolution.

47. The method of claim 46, wherein modifying the base print mask based on a first portion of the print mask parameters to generate a first modified print mask comprises modifying the base print mask to account for the ratio of the vertical nozzle resolution to the halftone data resolution and the ratio of the firing resolution to the halftone data resolution.

48. The method of claim 44, wherein receiving the plurality of print mask parameters comprises receiving the drop levels used and the nozzle range used.

49. The method of claim 48, wherein quantizing and aligning the second modified print mask based on a second portion of the print mask parameters to generate a quantized and aligned print mask comprises quantizing the second modified print mask to the drop levels used and aligning the second modified print mask to the nozzle range.

50. The method of claim 44, wherein the nozzle profile includes dead nozzle compensation.

51. The method of claim 44, wherein generating a base print mask utilizing N-based error diffusion comprises compensating for dead nozzles by shifting firings to adjacent nozzles.

52. The method of claim 51, wherein modifying the first modified print mask to generate a second modified print mask comprises modifying the first modified print mask to further compensate for any dead nozzles left uncompensated when generating the base print mask.

53. The method of claim 44, wherein modifying the first modified print mask to generate a second modified print mask comprises modifying the first modified print mask based on the nozzle profile to generate the second modified print mask.

54. The method of claim 44, wherein modifying the first modified print mask to generate a second modified print mask comprises modifying the first modified print mask based on a new nozzle profile to generate the second modified print mask.

55. The method of claim 44, wherein generating a base print mask utilizing N-based error diffusion comprises generating a base print mask utilizing a combination of tone-dependent error diffusion, plane-dependent error diffusion, and sequential-dependent error diffusion.

56. The method of claim 44, wherein converting the quantized and aligned print mask to a format capable of being recognized by one of printer hardware, printer firmware, and printer software.
